(19) United States
(12) Patent Application Publication
(10) Pub. No.: US 2025/0133008 A1
(43) Pub. Date: Apr. 24, 2025

(54) METHOD FOR ENABLING OMNIDIRECTIONAL PROGRAMMABLE CLIENT INTERFACE MODULE (OPCIM) FOR NETWORKING DEVICES

(71) Applicant: Cisco Technology, Inc., San Jose, CA (US)

(72) Inventors: Navdeep Sood, Bengaluru (IN); Praveen Kumar, Bengaluru (IN)

(21) Appl. No.: 18/381,332

(22) Filed: Oct. 18, 2023

(51) Int. Cl. H04L 45/00; H04L 49/55

(52) U.S. Cl. CPC H04L 45/22; H04L 49/557

(57) ABSTRACT

Techniques for programming an omnidirectional programmable client interface module (OPCIM) to receive a control signal and for configuring a set of outputs of a first output and a second output. Programming the OPCIM for routing the control signal from one input of the OPCIM to the first output and the second output of the OPCIM to output a first output signal and a second output signal to a first Line Card and a second Line Card coupled to each output, respectively. In response to a failure of at least either one of the Line Cards, automatically enabling reprogramming the OPCIM for routing the control signal to either Line Card that is still operational to prevent a service interruption in sending the control signal from one input to an output of either the first output or the second output to the Line Cards coupled to outputs of the OPCIM.

### TECHNICAL FIELD

The present disclosure relates generally to the Optical Networking and Auto-Programmability of protection scheme using an Omnidirectional Programmable Client Interface Module (OPCIM) for networking devices.

### BACKGROUND

As the demand for consumer and commercial internet networks is exponentially growing, in line with network devices are also progressively containing a higher number of Line Cards and ports. Often networking devices such as routers, switches, servers, firewalls, and transport devices are configured with a high number of ports and interfaces. The networking devices may be manufactured with their network placement in mind and as such include a plethora of ports and interfaces for access devices which usually are configured with relatively lower port counts to couple to physical Line Card slots. The physical Line Card slots may also be created with like port lower port counts and used for aggregation, edge, and core configuration of large nodes that are composed of several Line Card slots and can host many client ports available. Further depending on their positioning in customer site locations, the need for equipment of various Line Card slot capacities and pluggable capacities is made available.

It is desirable to enable an Omnidirectional Programmable Client Interface Module (OPCIM) for networking devices that is both cost-effective and convenient to configure a client traffic protection mechanism that is programmable and automatically usable for the protection of client traffic.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a diagram of an example Omnidirectional Programmable Client Interface Module (OPCIM) module according to some embodiments.

FIG. 2 illustrates a diagram of an exemplary set of OPCIM modules inserted between a set of client inputs and a router configured with a set of Line Cards (LCs) disposed therein according to some embodiments.

FIG. 3 illustrates a diagram of an exemplary set of OPCIM modules inserted between a set of client inputs and a router configured with a set of Line Cards where a failure event occurs in a Line Card (LC) requiring a re-routing of client connections according to some embodiments.

FIG. 4 illustrates a diagram of an Auto-Programmability of an exemplary protection scheme offered by the OPCIM according to some embodiments.

FIG. 5 is an exemplary diagram that illustrates the Auto-Programmability of a protection scheme with a failure report in a Line Card and rerouting of the network via the OPCIM according to some embodiments.

FIG. 6 is a flowchart of an example method for configuring the omnidirectional programmable client interface module (OPCIM) to receive a control signal to the OPCIM and to determine one or more paths for routing the control signal to one or more-Line Cards coupled to outputs of the OPCIM according to some embodiments.

FIG. 7 illustrates a computer architecture diagram showing an illustrative computer hardware architecture for implementing a computing device that can be utilized to implement aspects of the various technologies presented herein.

FIG. 8 illustrates a block diagram illustrating an example protection scheme system that can be utilized to implement various aspects of the technologies disclosed herein.

FIG. 9 illustrates a block diagram illustrating certain components of an example protection scheme system that can be utilized to implement various aspects of the technologies disclosed herein.

### DESCRIPTION OF EXAMPLE EMBODIMENTS

### Overview

This disclosure describes techniques enabling an Omnidirectional Programmable Client Interface Module OPCIM that is auto-programmable for protection configuration by either a Path Computation Element (PCE) or a co-located networking device.

In some embodiments, methods, and systems are described for an Omnidirectional Programmable Client Interface Module (OPCIM) for networking devices to configure a client traffic protection mechanism that is programmable and automatically usable for the protection of client traffic. In some embodiments, the methods and systems may be implemented in networking devices such as routers/switches to protect client traffic against a Line Card (LC) failure on a router/switch, an LC resource overflow, maintenance field events, etc. The method and system may offer enhanced client protection in a number of instances such as in LC failure, LC resource overload, and maintenance window activities.

In some embodiments, the method and system are configured by inserting the OPCIM between a client output and associated router input ports, where the client outputs serve as inputs to the OPCIM and the OPCIM serves as output to the router input ports. The OPCIM optical switch is enabled with auto programmability and is coupled to the client input (M inputs) and also connects the OPCIM output to N outputs. The OPCIM may be remotely configured and programmed and has a modular architecture to ensure that there is no common point of failure between multiple clients that are connected to the same OPCIM inputs. The OPCIM is configured to provide output protection that improves directly in proportion to the number of outputs that are used and also, the OPCIM is configured with a selection that chooses an appropriate balance of outputs to avoid excessive usage of output connections. In an implementation, the OPCIM reconfigures the inputs and outputs to reroute clients to other LCs if one of the current LC Network Processing Unit (NPU) or Application-Specific Integrated Circuit (ASIC) resources is experiencing an Out-Of-Resource (OOR) condition or another occurrence. The programming of the OPCIM is enabled in an auto-programmable manner in the event of a failure that requires the client connections to be rerouted to a different LC on the router and also can use a make-before-break method for performing controlled maintenance window events to mitigate impact to operations of traffic.

In some embodiments, the auto-programmable map includes a least latency path selection process that is enabled using the OPCIM. The OPCIM enables the selection and configuration of an alternate path with lower latency which is not feasible without OPCIM for the given client.

In some embodiments, a method of configuring an interface includes configuring at least one input for an omnidirectional programmable client interface module (OPCIM) to receive a control signal to the OPCIM. Then, configuring a set of outputs of the OPCIM comprising at least a first output and a second output to the OPCIM, and programming the OPCIM for routing the control signal from at least one input of the OPCIM to the first output and the second output of the OPCIM to output a first output signal and a second output signal to at least a first Line Card and a second Line Card coupled to each output respectively. In response to a failure of at least one Line Card, automatically enabling reprogramming the OPCIM for routing the control signal to either Line Card that is still operational to prevent a service interruption in sending the control signal from at least one input to an output of either the first output or the second output to at least one Line Card coupled to outputs of the OPCIM.

In some embodiments, the OPCIM is auto-programmable by at least one of a Path Computation Element (PCE), a controller, or a co-located networking device.

In some embodiments, the PCE, the controller, or the co-located networking device is configured to reprogram a port connection map for using an alternate path configured to send the control signal via the OPCIM an available Line Card.

In some embodiments, the programmable port connection map may be updated, after the PCE, the controller, or the co-located networking device evaluates a feasible alternate path.

In some embodiments, the OPCIM is auto-programmable to optically reprogram alternate connections between one or more inputs to one or more outputs coupled to one or more components that are subject to interruptions to enable service protection between multiple components, and wherein the OPCIM is enabled in an event of a failure to cause one or more connections to be rerouted to a different Line Card of a router which can provide a make-before-break process to mitigate traffic impact.

In some embodiments, the PCE, the controller, or co-located networking device includes at least one device of a router or switch that is configured to maintain or to reprogram the programmable port connection map between one or more inputs and one or more outputs associated with at least one OPCIM.

In some embodiments, the OPCIM is auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

In some embodiments, the number of control signals received by the OPCIM is balanced to be a proportional number of output signals generated by the OPCIM to balance usage of one or more outputs configured with the OPCIM to one or more Line Cards in use.

Additionally, the techniques described herein may be performed by a system and/or device having non-transitory computer-readable media storing computer-executable instructions that, when executed by one or more processors, performs the method described above.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Currently, networking devices such as routers, switches, servers, firewalls, and transport devices are configured with a very high number of ports and interfaces. This is because such devices are generally manufactured based on their network physical placement and the need to access other devices of the network that have a relatively smaller port count. The devices because of the high number of ports and interfaces may include a set of physical Line Card slots disposed therein that have been created for this requirement and aggregated together. For example, the devices may be configured to serve as the edge and core of the network with large-sized nodes with several Line Card slots and the capability to host hundreds of client ports that can be made available.

Further depending on the customer site location, the need for equipment of various Line Card slot capacities and pluggable capacities may also be made available. As the demand for consumer and commercial internet networks is exponentially growing, in-line configurations with the network devices are also being configured with progressively higher numbers of Line Cards and ports.

In some installations, Y cable protection may be used where the client is split into two different directions towards the aggregated and forwarded/switches layer. However, this implementation is faced with drawbacks as it may require that each client be configured with multiple sets of interfaces and cards on the aggregated/forwarded/switches. Also, this arrangement is rigid as it is hardwired with dedicated specified sets of interfaces, cards, and links on the aggregated and forwarded switch configured side without the flexibility of programmable paths. Another implementation is an end-to-end double-configured topology with diverse hardware and linkages. This configured topology halves the network capacity but requires increased (i.e., twice) amounts of hardware and other resources to meet a similar level of protection, and also lacks flexibility when implemented. Other limitations with this protection scheme may include the inability to reroute traffic in failure cases using auto programmable omnidirectional any port to any port connection capability, and in the event of a failure of a Line Card, an inability to recover operations with technical support which can often involve manual reconfiguring fiber and replacing cards. This can also lead to extended outages as any object (port) to any object (port) resource sharing for protection is either completely or minimally not feasible (i.e., because with hardwired connections there is no feasible mechanism re-route traffic in response to interruptive events such as scale related overflows). In other words, the implementation does not allow for omnidirectional interface protection processes to be implemented.

Also, the implementation is not easily adaptable as it lacks programmability. In some installations that are implemented, the customer is required to use a complete end-to-end double path diversity in accordance with the hardware, links, and geography that has been constructed. In this configuration, the drawbacks include that the network capacity usage may be halved, and often the configuration may require additional hardware to be used (i.e., twice the amount of required hardware and resources) to achieve the same level of protection. This configuration, even with the additional hardware requirements, may still lack (or is missing) programmability. The protection scheme is also hardwired and because of the lack of programmability, the configuration is unable to reroute traffic if a failure were to occur (i.e., the system cannot enable auto programmable omnidirectional such as any port to any port connection capability).

In various exemplary embodiments, systems, and methods are provided for implementing a very cost-effective and simple client traffic protection mechanism that is programmable and automatically usable for the protection of client traffic. In exemplary embodiments, systems, and methods are implemented in networking devices such as routers/switches to protect client traffic against a Line Card (LC) failure on a router/switch, an LC resource overflow, maintenance field events, etc. . . . In implementation, a system and method provided offer enhanced client protection in the LC failure, LC resource overload, and maintenance window activities.

In some embodiments, the OPCIM module is inserted between the client output and associated router input ports. The client outputs shall serve as inputs to the OPCIM module and the OPCIM module shall serve as outputs to router input ports. In some embodiments, the OPCIM optical switch is programmable and may be coupled to client inputs to M inputs and can connect OPCIM output to N outputs. For example, in a 2:5 OPCIM Module, there may be 2 inputs (signal coming from 2 clients towards router inputs) which will allow two client connections to be connected to the OPCIM device. For example, 5 outputs will enable the OPCIM to switch the two-client signal individually to 5 different output Line Cards as needed by the end-user programmatically. an appropriate balance of M outputs to avoid excessive usage of output connections (i.e., even though more connections improve protections, it also means there are more costs and more connections towards router Line Cards (the inputs) that may cause inefficiencies in implementation).

The OPCIM may also be configured with a modular architecture to ensure that there is no common point of failure of multiple clients connected to the same OPCIM inputs (and is easily replaceable). The system is configured to provide output protection with protection capability that improves directly in proportion to the number of M outputs that are used. However, the system is configured with a selection that chooses an

Although the systems and methods described herein are discussed with respect to one or more components, these systems and methods may be used with any type of device or system. Further, although particular examples are discussed with reference to component machines, alternate embodiments may include other types of devices including virtual devices that are bridged or located on a centralized connected (internal or external) platform.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

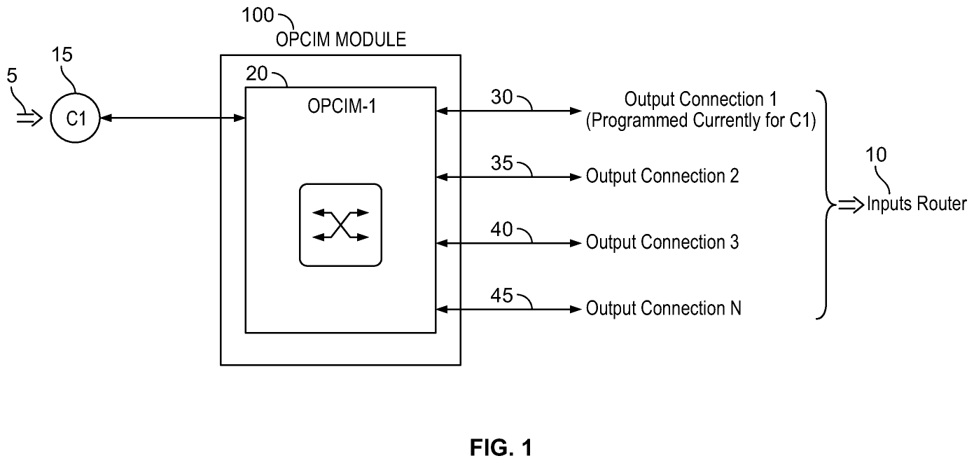

FIG. 1 illustrates a diagram of an example Omnidirectional Programmable Client Interface Module (OPCIM) module according to some embodiments. In FIG. 1, the OPCIM modular system 100 may be configured between a client output 5 and input router 10. In some embodiments, the OPCIM modular system 100 is capable of an M:N optical switching where M is the number of client inputs 15 (C1) and N is the number of N inputs to router inputs 10. For example, the client outputs (1 . . . M) shall serve as inputs to OPCIM-1 module 20, and OPCIM-1 module 20 shall serve as outputs to router input ports. The OPCIM optical switch mechanism 25 is configured to be programmable and at least can enable connecting a number of client inputs composed of M inputs to a number of OPCIM outputs composed of N outputs.

In some embodiments, in FIG. 1, a 1:4 OPCIM-1 module 20 configuration is shown where a single input (input 15 (C1)) is configured from a single client towards multiple router inputs which allows a single client to be connected (i.e., multiplexed) via the OPCIM optical switch mechanism 25 as an example to four outputs. In this case, the OPCIM optical switch mechanism 25 can switch or toggle between the single client at the input 15 to up to four outputs and subsequently enable four individual and/or different outputs to be connectable to up to four-Line Cards that may be used or required by the end-user programmatically. The OPCIM-1 20 is configured with the ability to provide output protection and the protection capability that is provided is directly proportional to the number of M outputs that have been configured.

In some embodiments, to avoid excessive usage of the outputs in operation, an appropriate balance between the usage of each output connection is implemented. Also, an increase in the number of outputs results in a corresponding increase in the number of connections that may be configured towards router Line Card inputs that are in operation. In FIG. 1, the example OPCIM modular system 100 (i.e., the OPCIM-1 20) is configured with a first input C1 15 where the client connection C1 is connected or coupled to a set of four outputs labeled as a first output 30 (Output connection 1) that is programmed currently for the first input C1 15, a second output 35 (Output connection 2), a third output 40 (Output connection 3) and a fourth output 45 (Output connection 4). However, the OPCIM modular system 100 is not constrained to the particular configuration of example 1:4 (M:N) OPCIM-1 Module 20. In other words, it is contemplated that there is no restriction on the number However there is no restriction on the number of M inputs and N outputs that may be implemented other than the fact that M should be less N. In the exemplary configuration, input C1 15 is programmatically connected to Output connection 1 (first output 30).

In other alternate embodiments, as an example, a 2:5 OPCIM Module may be configured or implemented in which there may be configured a set of multiple inputs, for example, 2 inputs that would include a set of signals being received from 2 different clients or individual clients sent towards a set of multiple router inputs. For example, this 2:5 configuration would enable two client connections to be coupled to the OPCIM device with a set of 5 outputs. In this instance, the OPCIM module may be implemented to switch or toggle the two-client signal individually or together with the five or up to the five different output Line Cards as desired or required by the end-user programmatically. In implementation, the OPCIM system may be of a modular design to ensure that there is no common point of failure between a set of multiple clients connected to the same set of OPCIM inputs.

In some embodiments, in an exemplary 2:5 OPCIM Module configured with 2 inputs (signal coming from 2 clients towards router inputs) in which two client connections are to be connected to the OPCIM device and for example 5 outputs which will enable the OPCIM to switch the two client signal individually to 5 different output Line Cards; in this instance, if one protection action is taken on OPCIM-1 already for client input 1, the OPCIM-1 can still take second protection action for client input 2 independent of action taken already for client input 1.

The above-noted examples are merely illustrative, and various changes may be made to achieve similar or the same results.

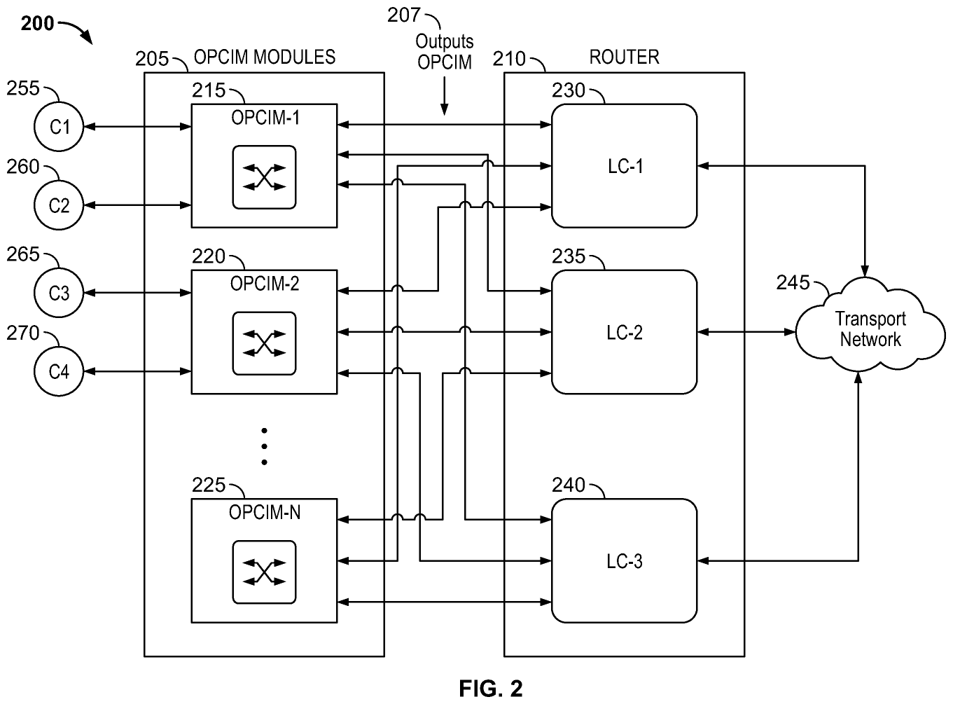

FIG. 2 illustrates a diagram of an exemplary set of OPCIM modules inserted between a set of client inputs and a router configured with a set of Line Cards disposed therein according to some embodiments. In FIG. 2, the OPCIM modular system 200 is configured to have both user-programmable and modular settings. In some embodiments, the OPCIM modular system 200 may be automatically programmable by a remote router coupled to one or more of the OPCIM outputs 207. In FIG. 2, the OPCIM modular system 200 may be configured with a set of OPCIM modules 205 of OPCIM-1 (215), OPCIM-2 (220) to OPCIM-N (225), each of which is a modular unit that is disposed within the framework to compose the set of OPCIM modules 205. For example, the OPCIM module 205 may be disposed of in various configurations in a housing and/or chassis depending on the implementation arrangement desired. In some embodiments, there may be a set of multiple inputs configured to the OPCIM modules 205 that may include, in this case, a total of four OPCIM inputs of a pair of inputs of first input 255 “C1” and a second input 260 “C2” configured towards OPCIM-1 (215), and another pair of inputs of a third input 265 “C3”, and a fourth input 270 “C4” towards OPCIM-2 (220). In some embodiments, OPCIM-1 (215) is configured with a set of multiple outputs that are individually or respectively connected to multiple Line Cards (LCs) of LC-1 (230), LC2 (235), and LC3 (240) of a router 210. In some embodiments, the OPCIM-2 (220) outputs are similarly individually coupled to a set of LCs of LC-1 (230), LC2 (235) and LC3 (240). A third OPCIM-3 (i.e., OPCIM-N (225)) with a set of outputs may be also configured and is individually coupled to a set of LC-1 (230), LC2 (235), and LC3 (240). The LC-1 (230), LC2 (235), and LC3 (240) are coupled to the transport network 245.

In some embodiments, one or more different arrangements of active path configurations may be implemented between each OPCIM and each LC (i.e., LC-1 (230), LC2 (235), and LC3 (240)). In an exemplary implementation, a current programmed active path may be configured consisting of the entities of the input, the OPCIM, and the Line Card. In an embodiment, a first active path is configured consisting of the first input 255 “C1” connected to the OPCIM-1 (215) which is connected to the LC-1 (230). In an embodiment, a second active path is configured and consists of the second input 260 “C2” connected to the OPCIM-1 (215) like the first input “C1” but which is connected to the LC-2 (235).

Another set of active paths may be configured with OPCIM-2 (220). In this instance, a third active path is configured consisting of the third input 265 “C3” connected to the OPCIM-2 (220) which is connected to the LC-1 (230). In another embodiment, a fourth active path is configured consisting of the fourth input 270 “C4” connected to the OPCIM-2 (220), like the third input “C3” but which is connected to the LC-2 (235).

In some embodiments, the OPCIM is remotely enabled with a modular architecture to ensure that there is no common point of failure of multiple clients connected to the same OPCIM inputs. Also, the OPCIM is configured to provide output protection that improves directly in proportion to the number of outputs that are used. The OPCIM is configured with a selection that chooses an appropriate balance of outputs to avoid excessive usage of output connections. The OPCIM can be reconfigured to reroute clients to other LCs in the event of one of the current LCs experiencing a Network processing unit (NPU) or Application-Specific Integrated Circuit (ASIC) resource Out Of Resource (OOR) condition.

In some embodiments, the programming of the OPCIM is enabled to be auto-programmable in the event of a failure that may cause the client connections to be rerouted to a different LC on the router; and using make-before-break processes for performing controlled maintenance window events to mitigate traffic impact. For example, the client inputs may be programmatically configured to be remotely controllable towards router connections. In implementation, the auto-programmability of the protection scheme is offered via OPCIM. OPCIM is auto-programmable for protection configuration by either the PCE or co-located networking device. Manual-programmability of protection scheme offered via OPCIM. OPCIM is Manual-programmable for protection configuration by the user remotely. The OPCIM may be modular to ensure that there is no shared risk between multiple clients connected to the same OPCIM inputs.

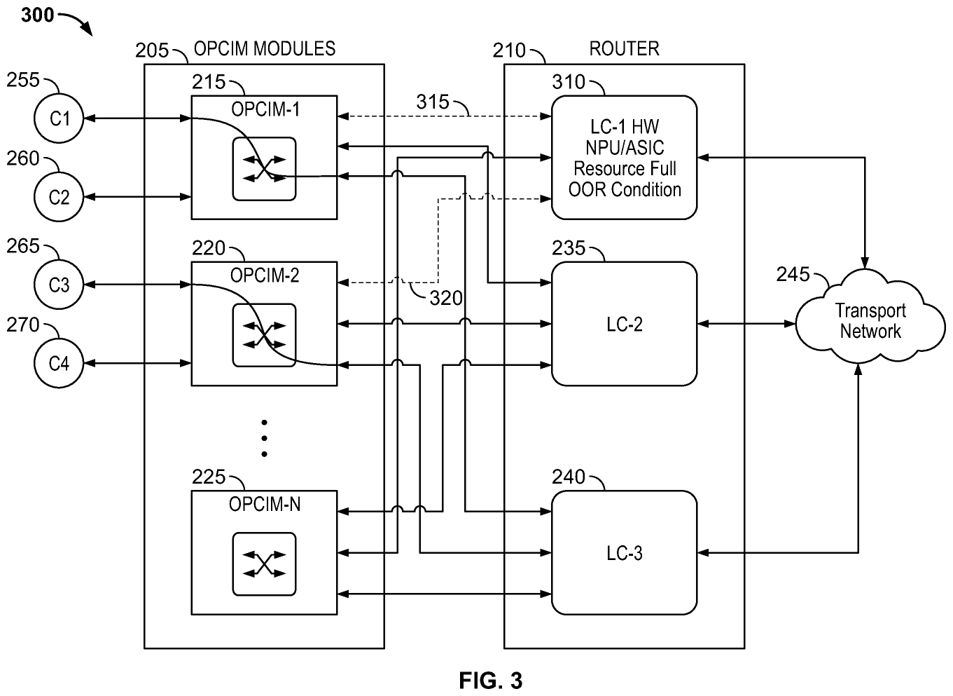

FIG. 3 illustrates a diagram of an exemplary set of OPCIM modules inserted between a set of client inputs and a router configured with a set of Line Cards where a failure event occurs in a Line Card requiring a re-routing of client connections according to some embodiments.

In FIG. 3, the OPCIM modular system 300 may be configured with a set of OPCIM modules 205 of OPCIM-1 (215), OPCIM-2 (220) to OPCIM-N (225), each of which is a modular unit that is disposed within the framework to compose the set of OPCIM modules 205 with outputs 315 and 320. The OPCIM module 205 includes four OPCIM inputs that consist of a pair of inputs of a first input 255 “C1” and a second input 260 “C2” configured towards OPCIM-1 (215) and another pair of inputs of a third input 265 “C3”, and a fourth input 270 “C4” towards OPCIM-2 (220). In some embodiments, OPCIM-1 (215) is configured with a set of multiple outputs (e.g., output 315, output 320) that are individually or respectively connected to multiple Line Cards (LCs) of LC-1 (230), LC2 (235), and LC3 (240) of a router 210. The OPCIM which is auto-programmable in the event of failure requires the client connections to be rerouted to a different LC on the router.

In FIG. 3, in various exemplary embodiments, the PCE is programmed to map or configure a set of initial or original programmed paths from each of the client inputs toward a respective IPCIM and then to a particular Line Card. The originally programmed paths are shown in FIG. 3 and are as follows: A first programmed path of Client input C1 (255) to OPCIM-1 (215) to LC1 (310), A second programmed path of Client input C2 (260) to OPCIM-1 (215) to LC2 (240), A third programmed path of Client input C3 (265) to OPCIM-2 (220) to LC1 (310), and a fourth programmed path of Client input C4 (270) to OPCIM-2 (220) to LC2 (240).

In an exemplary condition in which the router for example with the LC1 (310) Line Card experiences an NPU/ASIC resource OOR condition (e.g., such as due to any route table/MAC table going out of scale), the paths are reprogrammed.

In response to the event requiring the reprogramming of the paths, the OPCIM programmatically remotely enables new programmed paths that are individually configured or modified in the set of originally programmed paths as follows:

The first programmed path is modified and re-configured for a rerouted path of client input C1 (255) to OPCIM-1 (215) to LC3 (240). In other words, LC1 (310) is removed and replaced in the programmed path with LC3 (240). The second programmed path remains the same, as the fault is identified in LC1 (310), so the second programmed path is of Client input C2 (260) to OPCIM-1 (215) to LC2 (240). The third programmed path is modified with LC3 (240) instead of LC1 (310). The reprogrammed third path is now configured with Client input C3 (265) to OPCIM-2 (220) to LC3 (240). The fourth programmed path remains unchanged and is composed of client input C4 (270) to OPCIM-2 (220) to LC2 (240). The reprogramming of the paths is minimized to obviate the element with the fault to have a minimum impact on the routing and control signal operations via each OPCIM.

In some embodiments, the omnidirectional protection capability provides for a connection to be optically programmable between any input object (interface) to any output object (interface) for traffic/service protection and offers auto-programmable traffic protection in the event of Line Card hardware component failure in the network device. In some embodiments, the auto-programmable traffic protection is triggered by event-based actions and may be enabled in the event of ASIC/FPGA action or status change in the network device. For example, the Auto programmable traffic protection may be caused in the event of clock failure in the network device. Other instances of auto-programmable traffic protection may include protection in the event of pluggable failure in the network device, signal failure/error in the network device, fabric failure in the network device, Line Card out of resource condition in the network device, Line Card CPU/control failure in the network device, total router breakdown/failure in the network device, failure requiring Client connection to be rerouted to a different Line Card on router, and unidirectional link failure on the network device.

In some embodiments, the omnidirectional protection capability provides applicability to and the ability to protect for both client-side and line-side/transport-side failures, and the applicability and the ability to protect all networking devices having ports/PPM/interfaces.

In some embodiments, the omnidirectional protection is configured by the provision of cascading and daisy chaining of OPCIM modules to facilitate the connection and linking between different OPCIM inputs/outputs. For example, in a controller-based provision of cascading/daisy chaining of OPCIM modules to facilitate a multiple output connection possibility of PCE-based path diversity that is to be achieved with the OPCIM. The OPCIM enables controller-based shared risk diversity for the actual end-to-end data path. For example, client C1 can be router via Line Card LC1 and then C2 can be routed via another Line Card (other than LC1) to maintain diversity between C1 and C2 end-to-end

In some embodiments, in the event of failure requiring OPCIM protection as follows: A. Layer 2 (L2) Virtual Private Network (VPN) services, the PCE or associated router will reprogram the end client point with the associated L2 config via a new OPCIM protection path in both directions of a given service; B. Layer 3 (L3) VPN services—the PCE or associated router will reprogram the end client point with associated L3 and VRF configuration via a new OPCIM protection path in both directions of a given service; C. Layer 3 (L3) Forwarding—the PCE or associated router will reprogram the end client point with the associated L3 config via a new OPCIM protection path in both directions of a given service; D. Dense Wavelength Division Multiplexing (DWDM) type networks—the PCE or DWDM/Optical Transport Network (OTN) network devices will re-program the wave/OTN path via the new OPCIM protection path end-to-end bi-directionally.

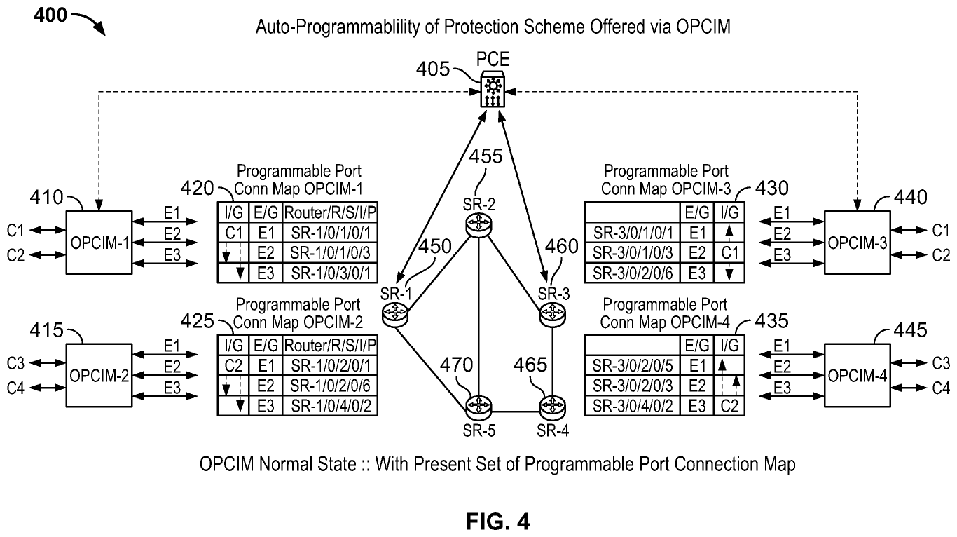

FIG. 4 is an exemplary diagram that illustrates the Auto-Programmability of the protection scheme offered via the OPCIM according to some embodiments. In FIG. 4, the example OPCIMs may be configured to be auto-programmable for protection by either the Path Computation Element (PCE) 405 or a co-located networking device. In FIG. 4, a segment routing transport network 400 is shown as an example with five transport layer routers which include a Service Router (SR)-1 (450), SR-2 (455), SR-3 (460), SR-4 (465), and SR-5 (470). The PCE 405 is connected to the five-transport layer router network and each Service Router to enable the computing of a route and to apply one or more constraints in route calculations. There is also shown a set of four OPCIM modules that include OPCIM-1 (410), OPCIM-2 (415), OPCIM-3 (440), and OPCIM-4 (445) which are configured with a set of programmable port connection maps of programmable port connection map OPCIM-1 (420), Programmable Port Connection Map OPCIM-2 (425) that include OPCIM-1 (410) and OPCIM-2 (415) enabled to be connected at SR-1 (450). Also, port connection map OPCIM-3 (430) and Programmable Port Connection Map OPCIM-4 (435) that include OPCIM-3 (440) and OPCIM-4 (445) enabled to be connected at SR-3 (460). Also, a set of programmed paths (i.e., the programmable port connection map) is configured of client input C1 to OPCIM-1 (410) to LC1, client input C2 to OPCIM-1 (410) to LC2, Client input C3 to OPCIM-2 (415) to LC1, and client input C4 to OPCIM-2 (415) to LC2 for each OPCIM individually. In the normal state, each OPCIM is individually or respectively controlled by the PCE 405, and the respective programmable port connection map is maintained as described.

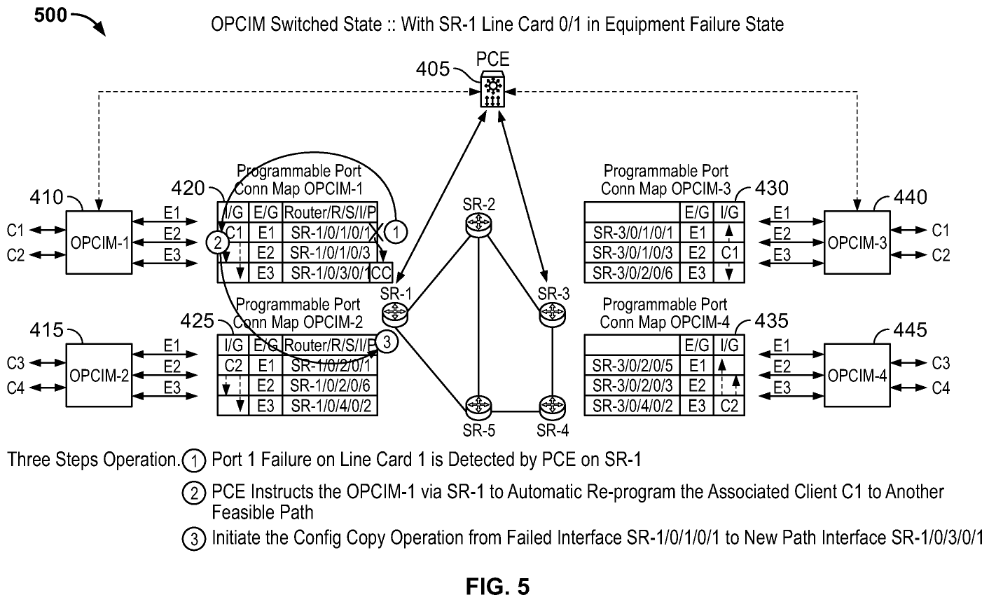

In some embodiments, with this configuration, in the case of a catastrophic failure occurring, such as the SR-1 Line Card 0/1 reports a port failure on the Line Card for port 0/1/0/1 which is the active path for client C1 on SR-1. The PCE 405 will instruct the collocated SR-1 and reprogram the port connection map to use an alternate path via Line Card 0/3 which is connected to E3 in the programmable port connection map. In this instance, a three-step procedure is used with reference to the diagram 500 of FIG. 5 to execute the protection switch via OPCIM-1. That is as outlined as follows: Step 1: When a Port 1 failure on Line Card 1 is detected by PCE on SR-1. In Step 2: The programmable port connection map is updated after the PCE evaluates a feasible alternate path and the C1 is connected via E3. In Step 3: a config copy operation is initiated from the failed interface SR-1/0/1/0/1 to program a new path interface SR-1/0/3/0/1. This 3-step process shall complete auto-programmable protection via the OPCIM

In some embodiments, aside from the auto-programmability, the Manual-programmability of the protection scheme may be offered via OPCIM. For Example, the OPCIM is Manual-programmable for protection configuration by the user remotely. The multiple OPCIMS of FIG. 5 may be configured in a modular architecture to ensure there is no shared risk between multiple clients connected to the same OPCIM inputs. The omnidirectional protection capability and connection described in FIG. 5 are optically programmable between any input object (interface) to any output object (interface) for traffic/service protection, and provide a robust protection scheme i.e., as long as the planned OPCIM design is followed the protection will be guaranteed. Aside from the PCE 405, any controller or co-located networking device such as a router/switch may be implemented with capabilities to maintain the programmable port connection map between input and output for each OPCIM.

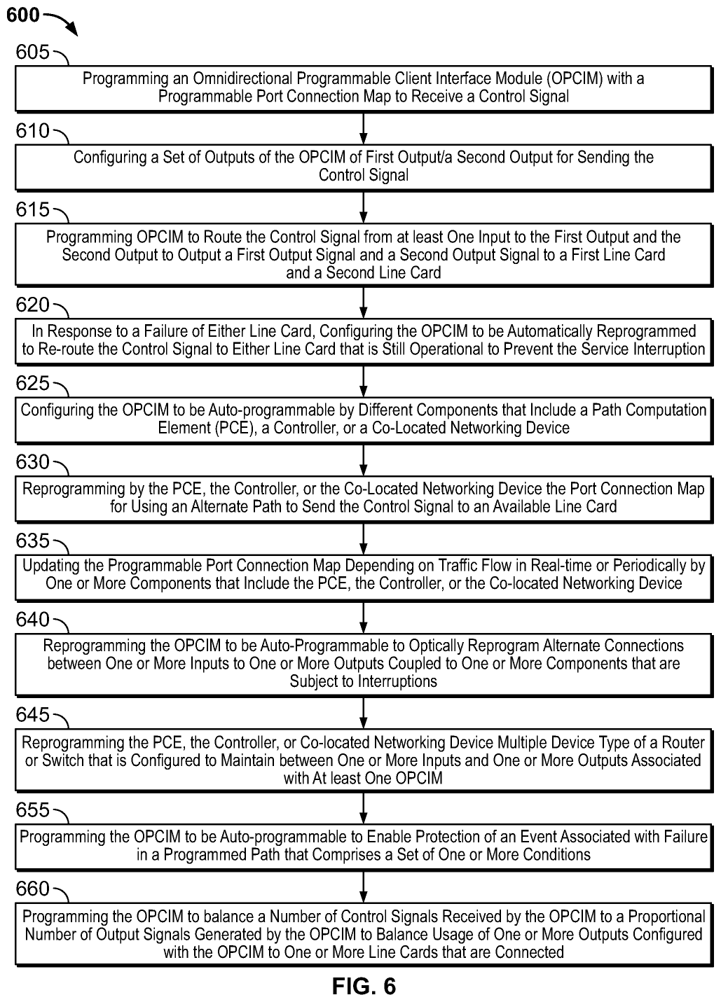

FIG. 6 is a flowchart of an example method for configuring the omnidirectional programmable client interface module (OPCIM) to receive a control signal to the OPCIM and to determine one or more paths for routing the control signal to one or more Line Cards coupled to outputs of the OPCIM according to some embodiments. In FIG. 6, in flowchart 600 at step 605, an omnidirectional programmable client interface module (OPCIM) is programmed with a programmable port connection map to receive a control signal. At step 610, a set of outputs of the OPCIM are configured of at least a first output and a second output for sending the control signal in accordance with the programmable port connection map. At step 615, the OPCIM is programmed to route the control signal from at least one input of the OPCIM to the first output and the second output of the OPCIM to output a first output signal and a second output signal to at least a first Line Card and a second Line Card that has been connected in a path to each output, respectively. At step 620, in response to a failure of either Line Card or any other service interruption issue including latency issues or other operational issues, the OPCIM is configured with a switching mechanism that can be automatically reprogramed to re-route the control signal to either Line Card that is still operational to prevent the service interruption in the sending of the control signal from the input to an output. At step 625, the OPCIM is enabled to be auto-programmable by different components that include a Path Computation Element (PCE), a controller, or a co-located networking device. At step 630, the PCE, the controller, or the co-located networking device may be configured to reprogram the port connection map for using an alternate path configured to send the control signal via the OPCIM an available Line Card. At step 635, the programmable port connection map may be updated depending on traffic flow in real-time or periodically by one or more components that include the PCE, the controller, or the co-located networking device (i.e., the update is performed based in part on evaluations of feasible alternate paths that are available). At step 640, the OPCIM may be configured to be auto-programmable to optically reprogram alternate connections between one or more inputs to one or more outputs coupled to one or more components that are subject to interruptions to enable service protection between multiple components. At step 645, the PCE, the controller, or co-located networking device may include multiple device types of a router or switch that is configured to maintain or to reprogram the programmable port connection map between one or more inputs and one or more outputs associated with at least one OPCIM. At step 655, the OPCIM may be auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output. At step 660, the OPCIM may be programmed to balance a number of control signals received by the OPCIM to a proportional number of output signals generated by the OPCIM to balance usage of one or more outputs configured with the OPCIM to one or more Line Cards that are connected.

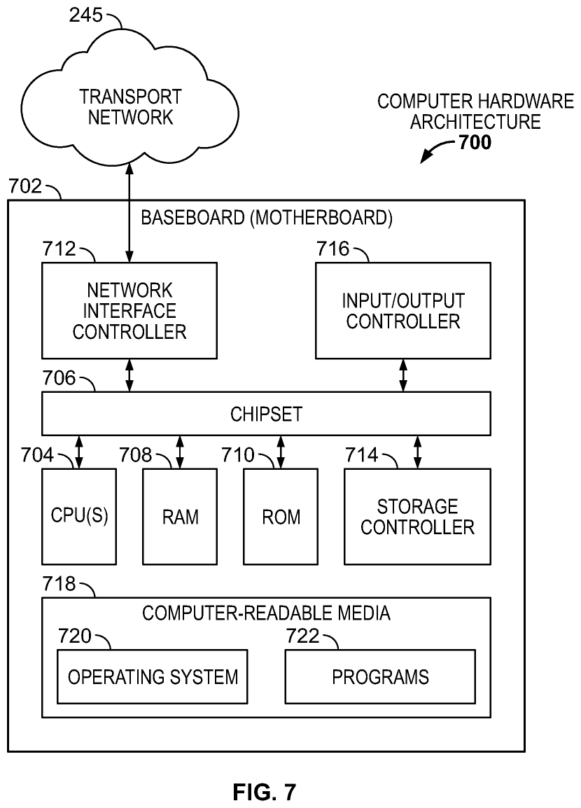

FIG. 7 shows an example of computer architecture for a computer 700 capable of executing program components for implementing the functionality described herein. The computer architecture shown in FIG. 7 illustrates a conventional server computer, workstation, desktop computer, laptop, tablet, network appliance, e-reader, smartphone, or other computing device, and can be utilized to execute any of the software components presented herein. The computer 700 may, in some examples, correspond to any of the servers, routers, or devices discussed herein that maybe connectable to a transport network 245. In some embodiments, computer 700 may include networked devices such as servers, switches, routers, hubs, bridges, gateways, modems, repeaters, access points, etc. Additionally, in some implementations, the programs or software discussed herein may be configured to perform operations performed by any of the devices. In some instances, the computer may correspond to any device described herein and be configured to perform operations performed by any device, and/or maybe a system of devices that perform the techniques described herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPU 704 can be a standard programmable processor that performs arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPU 704 and the remainder of the components and devices on the baseboard 702. The chipset 706 can provide an interface to a RAM 708, used as the main memory in the computer 700. The chipset 706 can further provide an interface to a computer-readable storage medium such as read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as Network 245. The chipset 706 can include functionality for providing network connectivity through a Network Interface Controller (NIC) 712, such as a gigabit Ethernet adapter. The NIC 712 is capable of connecting the computer 700 to other computing devices over network 245. It should be appreciated that multiple NICs 712 can be present in the computer 700, connecting the computer to other types of networks and remote computer systems.

The computer 700 can be connected to a storage device 718 (i.e., computer-readable media) that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other types of interfaces for physically connecting and transferring data between computers and physical storage units.

The computer 700 can store data on the storage device 718 by transforming the physical state of the physical storage units to reflect the information being stored. The specific transformation of the physical state can depend on various factors, in different embodiments of this description. Examples of such factors can include but are not limited to, the technology used to implement the physical storage units, whether the storage device 718 is characterized as primary or secondary storage, and the like.

For example, computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete components in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by devices described herein, and or any components included therein, may be supported by one or more devices similar to computer 700. Stated otherwise, some or all of the operations performed by the Controller/PCE or co-located networking device or any components included therein, may be performed by one or more computer devices (computer 700) operating in a system.

By way of example, and not limitation, computer-readable storage media can include volatile and non-volatile, removable, and non-removable media implemented in any method or technology. Computer-readable storage media includes but is not limited to, RAM, ROM, erasable programmable ROM (“EPROM”), electrically-erasable programmable ROM (“EEPROM”), flash memory, or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPU 704 transitions between states, as described above. According to one embodiment, the computer 700 has access to computer-readable storage media storing computer-executable instructions which, when executed by the computer 700, perform the various processes described herein. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other types of input devices. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more a router, a border router, and/or a server. The computer 700 may include one or more hardware processors CPUs 704 (or processors) configured to execute one or more stored instructions. The processor(s) may comprise one or more cores. Further, the computer 700 may include one or more network interfaces configured to provide communications between the computer 700 and other devices, such as the communications described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

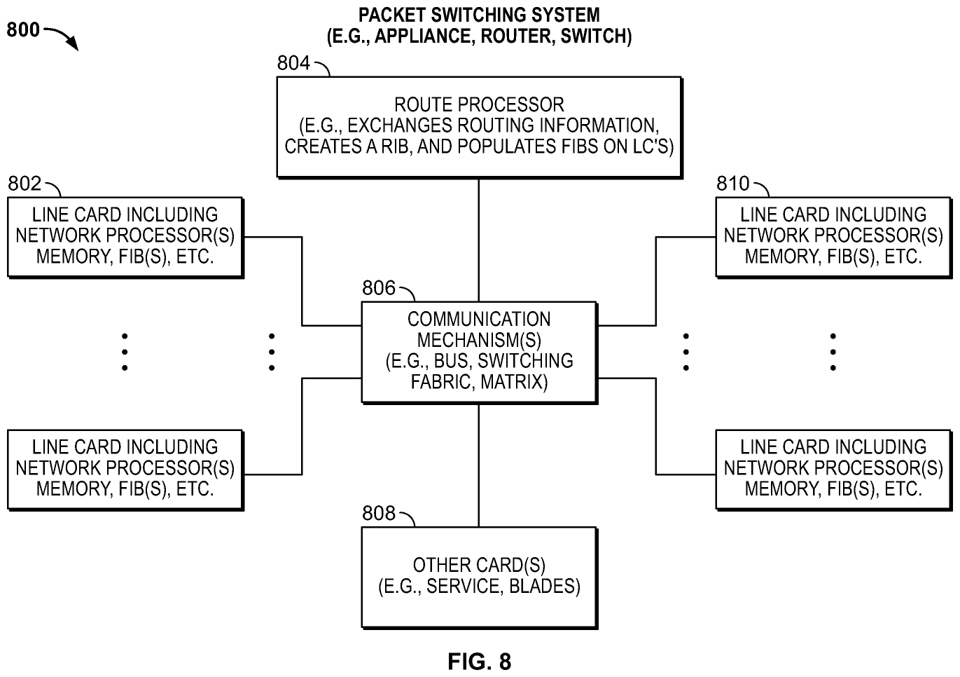

FIG. 8 illustrates a block diagram illustrating an example packet switching device (or system) 800 that can be utilized to implement various aspects of the technologies disclosed herein. In some examples, packet switching device(s) 800 may be employed in various networks, such as, for example, modular system 200 as described with respect to FIG. 2.

In some examples, a packet switching device 800 may comprise multiple line card(s) 802, 810, each with one or more network interfaces for sending and receiving packets over communications links (e.g., possibly part of a link aggregation group). The packet switching device 800 may also have a control plane with one or more processing elements for managing the control plane and/or control plane processing of packets associated with forwarding of packets in a network. The packet switching device 800 may also include other cards 808 (e.g., service cards, blades) which include processing elements that are used to process (e.g., forward/send, drop, manipulate, change, modify, receive, create, duplicate, apply a service) packets associated with forwarding of packets in a network. The packet switching device 800 may comprise hardware-based communication mechanism 806 (e.g., bus, switching fabric, and/or matrix, etc.) for allowing its different entities (e.g., Line card(s) 802, 810, and other cards 810, and route processor 804) to communicate. Line card(s) 802, 810 may typically perform the actions of being both an ingress and/or an egress line card 802, 810, in regard to multiple other particular packets and/or packet streams being received by, or sent from, packet switching device 800.

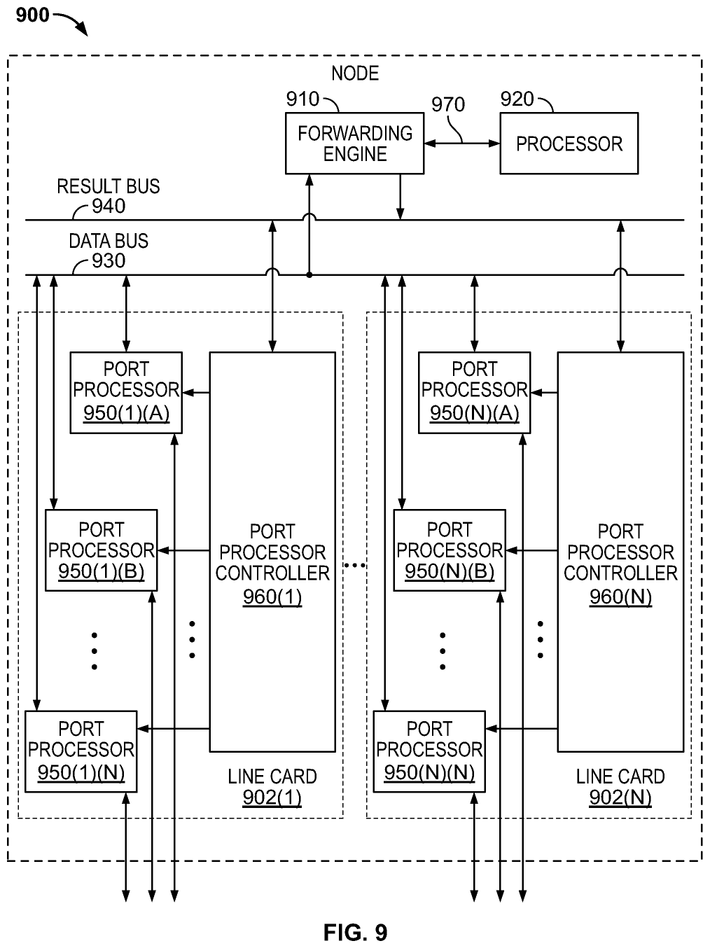

FIG. 9 illustrates a block diagram illustrating certain components of an example node 900 that can be utilized to implement various aspects of the technologies disclosed herein. In some examples, node(s) 900 may be employed in various networks, such as, for example, modular system 200 as described with respect to FIG. 2.

In some examples, node 900 may include any number of line cards 902 (e.g., line cards 902(1)-(N), where N may be any integer greater than 1) that are communicatively coupled to a forwarding engine 910 (also referred to as a packet forwarder) and/or a processor 920 via a data bus 930 and/or a result bus 940. Line cards 902(1)-(N) may include any number of port processors 950(1)(A)-(N)(N) which are controlled by port processor controllers 960(1)-(N), where N may be any integer greater than 1. Additionally, or alternatively, forwarding engine 910 and/or processor 920 are not only coupled to one another via the data bus 930 and the result bus 940, but may also communicatively coupled to one another by a communications link 970.

The processors (e.g., the port processor(s) 950 and/or the port processor controller(s) 960) of each line card 902 may be mounted on a single printed circuit board. When a packet or packet and header are received, the packet or packet and header may be identified and analyzed by node 900 (also referred to herein as a router) in the following manner. Upon receipt, a packet (or some or all of its control information) or packet and header may be sent from one of port processor(s) 950(1)(A)-(N)(N) at which the packet or packet and header was received and to one or more of those devices coupled to the data bus 930 (e.g., others of the port processor(s) 950(1)(A)-(N)(N), the forwarding engine 910 and/or the processor 920). Handling of the packet or packet and header may be determined, for example, by the forwarding engine 910. For example, the forwarding engine 910 may determine that the packet or packet and header should be forwarded to one or more of port processors 950(1)(A)-(N)(N). This may be accomplished by indicating to corresponding one(s) of port processor controllers 960(1)-(N) that the copy of the packet or packet and header held in the given one(s) of port processor(s) 950(1)(A)-(N)(N) should be forwarded to the appropriate one of port processor(s) 950(1)(A)-(N)(N). Additionally, or alternatively, once a packet or packet and header has been identified for processing, the forwarding engine 910, the processor 920, and/or the like may be used to process the packet or packet and header in some manner and/or maty add packet security information in order to secure the packet. On a node 900 sourcing such a packet or packet and header, this processing may include, for example, encryption of some or all of the packet's or packet and header's information, the addition of a digital signature, and/or some other information and/or processing capable of securing the packet or packet and header. On a node 900 receiving such a processed packet or packet and header, the corresponding process may be performed to recover or validate the packet's or packet and header's information that has been secured.

Clause 1. A method of configuring an interface, comprising: configuring at least one input for an omnidirectional programmable client interface module (OPCIM) to receive a control signal to the OPCIM; configuring a set of outputs of the OPCIM comprising at least a first output and a second output to the OPCIM; programming the OPCIM for routing the control signal from the at least one input of the OPCIM to the first output and the second output of the OPCIM to output a first output signal and a second output signal to at least a first Line Card and a second Line Card coupled to each output respectively; and in response to a failure of at least either Line Card, automatically enabling reprogramming the OPCIM for routing the control signal to either Line Card that is still operational to prevent a service interruption in sending of the control signal from the at least one input to an output of either the first output or the second output to at least one Line Card coupled to outputs of the OPCIM.

Clause 2. The method of clause 1, wherein the OPCIM is auto-programmable by at least one of a Path Computation Element (PCE), a controller, or a co-located networking device.

Clause 3. The method of clause 2, wherein the PCE, the controller, or the co-located networking device is configured to reprogram a port connection map for using an alternate path configured to send the control signal via the OPCIM an available Line Card.

Clause 4. The method of clause 3, further comprising: updating, a programmable port connection map, after the PCE, the controller, or the co-located networking device evaluates a feasible alternate path.

Clause 5. The method of clause 4, wherein the OPCIM is auto-programmable to optically reprogram alternate connections between one or more inputs to one or more outputs coupled to one or more components that are subject to interruptions to enable service protection between multiple components, and wherein the OPCIM is enabled in an event of a failure to cause one or more connections to be rerouted to a different Line Card of a router which can provide a make-before-break process to mitigate traffic impact.

Clause 6. The method of clause 5, wherein the PCE, the controller, or co-located networking device comprises at least one device of a router or switch that is configured to maintain or to reprogram the programmable port connection map between one or more inputs and one or more outputs associated with at least one OPCIM.

Clause 7. The method of clause 6, wherein the OPCIM is auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

Clause 8. The method of clause 1, further comprising: balancing a number of control signals received by the OPCIM to a proportional number of output signals generated by the OPCIM to balance usage of one or more outputs configured with the OPCIM to one or more Line Cards in use.

Clause 9. An omnidirectional programmable client interface module (OPCIM) comprising at least one input; at least one output; and at least one line switching component; wherein the at least one line switching component is configured in response to a controller to route a control signal from the at least one input to the at least one output; wherein in response to the controller detecting a failure at the at least one output, the at least one line switching component is configured to respond to the controller to reprogram a port connection map associated with the at least one line switching component and to reroute the control signal from the at least one input to another output configured with the OPCIM.

Clause 10. The OPCIM of clause 9, wherein the OPCIM is auto-programmable by at least one of the controller, a Path Computation Element (PCE), or a co-located networking device.

Clause 11. The OPCIM of clause 10, wherein the port connection map is reprogrammed by one of the PCE or the co-located networking device to implement one or more alternate paths for sending the control signal to one or more outputs that are available with the OPCIM.

Clause 12. The OPCIM of clause 11 wherein the port connection map is updated by one of the controller, the PCE, or the co-located networking device based on a determination of available paths for sending the control signal to one or more outputs of the OPCIM.

Clause 13. The OPCIM of clause 12, wherein the controller, the PCE, or the co-located networking device comprises at least one of a device of a router or switch that is configured to maintain or to reprogram the port connection map between one or more inputs and one or more outputs associated with at least one OPCIM.

Clause 14. The OPCIM of clause 13, wherein one or more outputs of the OPCIM are configured to be coupled to one or more Line Cards (LCs) respectively.

Clause 15. The OPCIM of clause 14, wherein the OPCIM is auto programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

Clause 16. A system comprising: one or more processors; and one or more non-transitory computer-readable media storing computer-executable instructions that, when executed by the one or more processors, cause the one or more processors to perform operations comprising: configuring at least one input for an omnidirectional programmable client interface module (OPCIM) to receive a control signal to the OPCIM; configuring a set of outputs of the OPCIM comprising at least a first output and a second output to the OPCIM; programming the OPCIM for routing the control signal from the at least one input of the OPCIM to the first output and the second output of the OPCIM to output a first output signal and a second output signal to at least a first Line Card and a second Line Card coupled to each output respectively; and in response to a failure of at least either Line Card, automatically enabling reprogramming the OPCIM for routing the control signal to either Line Card that is still operational to prevent a service interruption in sending of the control signal from the at least one input to an output of either the first output or the second output to at least one Line Card coupled to outputs of the OPCIM.

Clause 17. The system of clause 16, the operations further comprising: enabling auto programming by at least one of a Path Computation Element (PCE), a controller, or a co-located networking device.

Clause 18. The system of clause 17, wherein the operations further comprising: reprograming a port connection map to use an alternate path for sending the control signal via the OPCIM to a Line Card.

Clause 19. The system of clause 18, the operations further comprising: updating the port connection map in response to a determination of an alternate feasible path for omnidirectional service protection between one or more inputs to one or more outputs coupled to one or more components of paths that are subject to interruptions enabling end-to-end service protection.

Clause 20. The system of clause 19, wherein the OPCIM is auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method of configuring an interface, comprising:
configuring at least one input for an omnidirectional programmable client interface module (OPCIM) to receive a control signal to the OPCIM;
configuring a set of outputs of the OPCIM comprising at least a first output and a second output to the OPCIM;
programming the OPCIM for routing the control signal from the at least one input of the OPCIM to the first output and the second output of the OPCIM to output a first output signal and a second output signal to at least a first Line Card and a second Line Card coupled to each output respectively; and
in response to a failure of at least either Line Card, automatically enabling reprogramming the OPCIM for routing the control signal to either Line Card that is still operational to prevent a service interruption in sending of the control signal from the at least one input to an output of either the first output or the second output to at least one Line Card coupled to outputs of the OPCIM.

2. The method of claim 1, wherein the OPCIM is auto-programmable by at least one of a Path Computation Element (PCE), a controller, or a co-located networking device.

3. The method of claim 2, wherein the PCE, the controller, or the co-located networking device is configured to reprogram a port connection map for using an alternate path configured to send the control signal via the OPCIM an available Line Card.

4. The method of claim 3, further comprising:
updating, a programmable port connection map, after the PCE, the controller, or the co-located networking device evaluates a feasible alternate path.

5. The method of claim 4, wherein the OPCIM is auto-programmable to optically reprogram alternate connections between one or more inputs to one or more outputs coupled to one or more components that are subject to interruptions to enable service protection between multiple components, and wherein the OPCIM is enabled in an event of a failure to cause one or more connections to be rerouted to a different Line Card of a router which can provide a make-before-break process to mitigate traffic impact.

6. The method of claim 5, wherein the PCE, the controller, or co-located networking device comprises at least one device of a router or switch that is configured to maintain or to reprogram the programmable port connection map between one or more inputs and one or more outputs associated with at least one OPCIM.

7. The method of claim 6, wherein the OPCIM is auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

8. The method of claim 1, further comprising:
balancing a number of control signals received by the OPCIM to a proportional number of output signals generated by the OPCIM to balance usage of one or more outputs configured with the OPCIM to one or more Line Cards in use.

9. An omnidirectional programmable client interface module (OPCIM) comprising:
at least one input;
at least one output; and
at least one line switching component;
wherein the at least one line switching component is configured in response to a controller to route a control signal from the at least one input to the at least one output;
wherein in response to the controller detecting a failure at the at least one output, the at least one line switching component is configured to respond to the controller to reprogram a port connection map associated with the at least one line switching component and to reroute the control signal from the at least one input to another output configured with the OPCIM.

10. The OPCIM of claim 9, wherein the OPCIM is auto-programmable by at least one of the controller, a Path Computation Element (PCE), or a co-located networking device.

11. The OPCIM of claim 10, wherein the port connection map is reprogrammed by one of the PCE or the co-located networking device to implement one or more alternate paths for sending the control signal to one or more outputs that are available with the OPCIM.

12. The OPCIM of claim 11 wherein the port connection map is updated by one of the controller, the PCE, or the co-located networking device based on a determination of available paths for sending the control signal to one or more outputs of the OPCIM.

13. The OPCIM of claim 12, wherein the controller, the PCE, or the co-located networking device comprises at least one of a device of a router or switch that is configured to maintain or to reprogram the port connection map between one or more inputs and one or more outputs associated with at least one OPCIM.

14. The OPCIM of claim 13, wherein one or more outputs of the OPCIM are configured to be coupled to one or more Line Cards (LCs) respectively.

15. The OPCIM of claim 14, wherein the OPCIM is auto programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.

16. A system comprising:
one or more processors; and
one or more non-transitory computer-readable media storing computer-executable instructions that, when executed by the one or more processors, cause the one or more processors to perform operations comprising:
configuring at least one input for an omnidirectional programmable client interface module (OPCIM) to receive a control signal to the OPCIM;
configuring a set of outputs of the OPCIM comprising at least a first output and a second output to the OPCIM;
programming the OPCIM for routing the control signal from the at least one input of the OPCIM to the first output and the second output of the OPCIM to output a first output signal and a second output signal to at least a first Line Card and a second Line Card coupled to each output respectively; and
in response to a failure of at least either Line Card, automatically enabling reprogramming the OPCIM for routing the control signal to either Line Card that is still operational to prevent a service interruption in sending of the control signal from the at least one input to an output of either the first output or the second output to at least one Line Card coupled to outputs of the OPCIM.

17. The system of claim 16, the operations further comprising:
enabling auto programming by at least one of a Path Computation Element (PCE), a controller, or a co-located networking device.

18. The system of claim 17, wherein the operations further comprising:
reprograming a port connection map to use an alternate path for sending the control signal via the OPCIM to a Line Card.

19. The system of claim 18, the operations further comprising:
updating the port connection map in response to a determination of an alternate feasible path for omnidirectional service protection between one or more inputs to one or more outputs coupled to one or more components of paths that are subject to interruptions enabling end-to-end service protection.

20. The system of claim 19, wherein the OPCIM is auto-programmable to enable protection of an event associated with failure in a programmed path that comprises a set of one or more conditions associated with a Line Card, an ASIC, a clock, a pluggable device, a controller signal error or failure, a fabric, resource condition, a CPU control failure, a router breakdown, an unidirectional link, and a failure caused by a rerouting of a path between an input and an output.
